(19) United States
(12) Patent Application Publication
(10) Pub. No.: US 2022/0231584 A1
(43) Pub. Date: Jul. 21, 2022

(54) METHOD AND APPARATUS FOR MANUFACTURING A HOUSING

(71) Applicant: PROGRESS-WERK Oberkirch AG, Oberkirch (DE)

(72) Inventors: Martin SPINNER, Renchen (DE); Tobias BIGOTT, Oberkirch (DE)

(21) Appl. No.: 17/716,346

(22) Filed: Apr. 8, 2022

Related U.S. Application Data
(63) Continuation of application No. PCT/EP2020/074921, filed on Sep. 7, 2020.

(30) Foreign Application Priority Data
Oct. 15, 2019 (DE) 10 2019 127 797.3

(51) Int. Cl. H02K 15/14; H02K 5/06; B21D 22/26

(52) U.S. Cl. CPC H02K 15/14; B21D 22/26; H02K 5/06

(57) ABSTRACT

A method of and an apparatus for manufacturing a housing is disclosed. The housing to be manufactured has a sleeve-shaped housing wall extending about a longitudinal axis of the housing and a cover disposed inside the housing wall transverse to the longitudinal axis at a predetermined position between longitudinal ends of the housing wall. The method comprises providing a precursor of the housing, in which the cover is formed integrally with the housing wall and is arranged at one of the longitudinal ends of the housing wall, further separating the cover from the housing wall and displacing the cover relative to the housing wall in the direction of the longitudinal axis from the one longitudinal end into the predetermined position.

### CROSS-REFERENCE TO RELATED APPLICATIONS

This application is a continuation of international patent application PCT/EP2020/074921, filed on 7 Sep. 2020 designating the U.S., which international patent application claims priority from German patent application No. 10 2019 127 797.3 filed on 15 Oct. 2019. The entire contents of these priority applications are incorporated herein by reference.

### FIELD OF THE INVENTION

The invention relates to a method and an apparatus for manufacturing a housing having a sleeve-shaped housing wall extending about a longitudinal axis of the housing and a cover arranged inside the housing wall transverse to the longitudinal axis at a predetermined position between longitudinal ends of the housing wall.

### BACKGROUND

A housing of the type mentioned above can, for example, be a housing for an electric motor. The cover may have a bearing flange for the motor shaft. The cover is located inside the housing wall, i.e. in the cavity formed by the housing wall at a position spaced from both longitudinal ends of the housing wall. The cover divides the interior of the housing into a first subspace, which serves to accommodate the stator of the electric motor, and the other subspace can accommodate, for example, the control electronics for the motor.

Such a complex housing cannot be manufactured in one piece from a blank using conventional forming processes such as deep drawing because of the cover located in the cavity of the housing. It is conceivable to manufacture such a housing in one piece or monolithically using a die casting process. However, a housing produced by die casting has the disadvantage of high cost.

A concept is also conceivable in which such a complex housing is manufactured from individual parts, each made from a blank in a forming process, which are assembled together after their individual manufacture. For example, the sleeve-shaped housing wall and the cover could be manufactured separately from one blank each in a deep-drawing process, and the cover could then be inserted into the predetermined position within the housing wall. However, the production of individual parts with one tool each on corresponding separate apparatuses is also disadvantageous in terms of manufacturing costs.

### SUMMARY

An object of the invention is to provide a method of manufacturing a housing of the type mentioned at the beginning, with which such a housing can be manufactured with low manufacturing costs.

A further object of the invention is to provide an apparatus for manufacturing such a housing.

According to the present disclosure, a method of manufacturing a housing is provided, the housing to be manufactured having a sleeve-shaped housing wall extending about a longitudinal axis of the housing and a cover disposed inside the housing wall transverse to the longitudinal axis at a predetermined position between longitudinal ends of the housing wall, the method comprising:
providing a precursor of the housing, in which the cover is formed integrally with the housing wall and is disposed at one of the longitudinal ends of the housing wall,
separating the cover from the housing wall,
displacing the cover relative to the housing wall in the direction of the longitudinal axis from one longitudinal end into the predetermined position.

The method according to the invention thus departs from the concept of manufacturing a complex housing by first manufacturing individual parts of the housing separately and then assembling them. Instead, a precursor of the housing is first provided, in which the cover is formed in one piece, i.e. monolithically, with the housing wall and is arranged at one of the longitudinal ends of the housing wall.

The monolithic precursor of the housing can advantageously be produced by conventional forming processes from a single blank in a forming device. In the precursor of the housing, the cover is already in the correct position in the direction transverse to the longitudinal axis, so that in contrast to separate production of the cover and housing wall, a positioning process in this respect is advantageously not required. However, the cover is not yet at the axial predetermined position between the longitudinal ends within the housing wall. Therefore, the method according to the invention further provides for separating the cover from the housing wall after manufacturing the precursor of the housing and for displacing it relative to the housing wall along the longitudinal axis of the housing wall from the one longitudinal end at which the cover is located in the precursor of the housing into the predetermined position (desired position) and thus positioning it. After displacement to the desired position, the cover can be joined to the housing wall in the desired position.

The process according to the invention is characterized by the fact that the separation and positioning (displacing) of the cover and, if necessary, the production of the precursor of the housing and, if necessary, the joining can be carried out in a single production line. In this case, the production of the precursor, the separating and positioning of the cover and, if necessary, the joining can be carried out in a press cycle. The same production line can also include a joining station.

According to the present disclosure, an apparatus for carrying out the method according to the present disclosure comprises:
a separating device for separating the cover from the housing wall, and
a positioning device for displacing the cover relative to the housing wall along the longitudinal axis into the predetermined position.

Preferably, the apparatus comprises a manufacturing device for manufacturing the precursor of the housing. Furthermore, the device preferably comprises a joining device for joining the cover to the housing wall in the predetermined position.

Preferably, the production of the precursor of the housing and the separation and displacement of the cover are carried out in different working stations of the same production line. For this purpose, the apparatus according to the invention preferably has a manufacturing device for manufacturing the precursor of the housing.

The time and cost of manufacturing the housing is thus further reduced.

In the method according to the invention, providing the precursor of the housing preferably comprises a one-piece, i.e. monolithic, forming of the housing wall and the cover from a same blank.

All conventional forming processes, such as deep drawing, reverse drawing, necking, which are carried out in one or more forming stages, can be used as forming processes.

For this purpose, the apparatus according to the invention may comprise a forming device for jointly forming the cover and the housing wall in one piece from a same blank in one or more forming stages.

In another preferred embodiment of the method, providing the precursor of the housing comprises forming the cover with a skirt extending in longitudinal direction of the housing wall along a partial length of the housing wall and circumferentially about the longitudinal axis.

The advantage of this measure is that the skirt provides a flat abutment of the cover against the inside of the housing wall, thus providing a sufficient surface for joining the cover to the housing wall.

Further preferably, an outer diameter of the skirt corresponds to the inner diameter of the housing wall.

It is advantageous here that the skirt rests against the inner surface of the housing wall without an air gap, so that the cover can be joined to the housing wall in a pressure-tight manner via the skirt after the cover has been displaced into the desired position without additional material. The outer diameter of the skirt can be adapted to the inner diameter of the housing wall in such a way that the cover holds itself in the desired position against the inner surface of the housing wall.

In another preferred embodiment of the method, the cover is joined to the housing wall mechanically, thermally and/or thermomechanically.

Mechanical joining may be realized, as optionally provided in a further embodiment, by engaging the housing wall with holes in the skirt of the cover, for example by pressing the housing wall into the holes in the skirt. A further advantage here is that the cover is held against rotation relative to the housing wall via the engagement of the housing wall in the holes of the skirt. Instead of pressing the housing wall into holes in the skirt of the cover, mechanical joining can also be carried out completely without holes, for example by means of crimp connections such as toxing, clinching, etc.

The perforation of the skirt can be carried out as part of the production of the precursor of the housing. Accordingly, in a preferred embodiment, the apparatus according to the invention comprises a perforating device for perforating the skirt of the cover. In a further embodiment of the device, the joining device may be arranged to engage the housing wall with the holes of the skirt.

A thermal joining may include, for example, welding the cover to the housing wall. A thermomechanical joining may comprise a combination of thermal and mechanical joining, for example, the mechanical joining may be performed with the application of heat.

Preferably, the joining of the cover with the housing wall is performed in the same device as the separation and displacement of the cover.

In another preferred embodiment of the method, providing the precursor of the housing comprises forming the cover as a bearing flange.

The bearing flange can be designed to accommodate a shaft. The central opening of the bearing flange can be introduced during the one-piece forming of the housing wall and the cover, i.e. before the cover is separated from the housing wall.

In a further preferred embodiment of the apparatus, the separating device has a separating plunger onto which the housing wall with cover can be placed, and a separating die which is designed to separate the cover from the housing wall.

The separating die can, for example, have a circumferential cutting edge which engages at the transition of the cover to the housing wall and shears or cuts off the housing wall from the cover by relative movement of the cutting die and separating plunger. The advantage of such a design of the separating device is that it can be integrated into a press in a simple manner.

The positioning device preferably has a pusher designed to displace the cover relative to the housing wall.

Such a pusher can also be easily integrated into a press. The pusher can, for example, engage the cover from above and displace it relative to the housing wall into the desired position after the cover has been separated from the housing wall.

With the method and apparatus according to the invention, a complex housing can be produced with low weight from a single blank with little use of tooling in a single apparatus or production line with little expenditure of time and cost.

For the purposes of the present invention, a “blank” is understood to be a sheet metal blank with the same material quality throughout, or a so-called tailored blank, i.e. a sheet metal blank which can be composed of different material qualities and sheet thicknesses, or a roll-clad sheet metal blank. The material of the blank is metallic, for example steel or aluminum. Composite materials made of different metals or of metal and plastic that can be formed are also possible.

Further advantages and features result from the following description and the attached drawings.

It is to be understood that the features mentioned above and the features to be explained below can be used not only in the combination indicated in each case, but also in other combinations or on their own, without departing from the scope of the present invention.

### BRIEF DESCRIPTION OF THE DRAWINGS

Exemplary embodiments of the invention are shown in the drawings and are described in more detail with reference thereto hereinafter. In the drawings:

FIG. 1 shows a housing in a sectional view along a longitudinal axis of the housing;

FIG. 2 shows a precursor of the housing in FIG. 1 in a process stage of a method of manufacturing the housing;

FIG. 2A shows a blank from which the precursor is produced;

FIG. 3 shows another process stage of the method of manufacturing the housing in

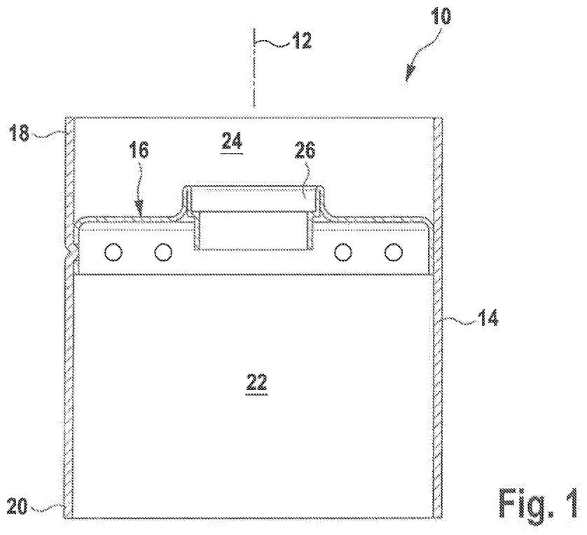

FIG. 1;

FIG. 4 shows another process stage of the method of manufacturing the housing in

FIG. 1;

FIG. 5 shows a longitudinal section through part of a working station of an apparatus for manufacturing the housing in FIG. 1 in a working position;

FIG. 6 shows a longitudinal section through the working station of the apparatus with a further part of the working station in a further working position;

FIG. 7 shows a longitudinal section through the working station in FIG. 6 in a further working position;

FIG. 8 shows a longitudinal section through the working station in FIG. 6 in a further working position;

FIG. 9 shows a longitudinal section through the working station in FIG. 6 in a further working position;

FIG. 10 shows a longitudinal section through the working station in FIG. 6 in a further working position;

FIG. 11 shows the part of the working station in FIG. 5 in a further working position; and

FIG. 12 shows the part of the working station in FIG. 5 in a still further working position.

### DETAILED DESCRIPTION OF EXEMPLARY EMBODIMENTS

FIG. 1 shows a housing labeled with the general reference sign 10 in a longitudinal section along a longitudinal axis 12 of the housing. The housing 10 is rotationally symmetrical about the longitudinal axis 12, although non-rotationally symmetrical geometries are also possible.

The housing 10 has a sleeve-shaped housing wall 14 extending around the longitudinal axis 12 and a cover 16. The housing 10 is thus formed in multiple parts. In the present case, without limiting generality, the housing 10 is formed from two parts, namely the housing wall 14 and the cover 16. The housing 10 may also have more than two parts. However, as will be described later, the cover 16 and the housing wall 14 have not been manufactured as separate individual parts, but have been monolithically manufactured from one blank.

The cover 16 is arranged at a predetermined position between a first longitudinal end 18 and a second longitudinal end 16 inside the housing wall 14 and extends transverse to the longitudinal axis 12 of the housing. The predetermined position of the cover 16 is spaced from both longitudinal ends. The cover 16 is joined to the housing wall 14, as will be described later.

The housing 10 is made overall from sheet metal, for example sheet steel or sheet aluminum. Other materials, for example also hybrid materials of metal and plastic, which can be formed in forming processes, are also possible. The wall thickness of the cover 16 is shown in FIG. 1 to be different from the wall thickness of the housing wall, but it is to be understood that the wall thicknesses of the cover 16 and housing wall 14 can also be identical. Different wall thicknesses can be realized, for example, by using a so-called tailored blank or a roll-clad blank as the starting blank.

The housing 10 may be, for example, a housing for an electric motor, wherein a first sub-space 22 of the interior of the housing 10 is for receiving a stator of the electric motor and a second sub-space 24 of the interior of the housing 10 is for receiving control electronics for the motor. The cover 16 separates the two compartments 22 and 24. The cover 16 may be configured as a bearing seat as shown, in which case the cover 16 includes a bearing flange 26. The bearing flange 26 may serve to receive a bearing shaft of the motor.

The cover 16 may also have different geometries in other applications of the housing 10, i.e., the bearing flange may have a different configuration or may be omitted.

Due to the arrangement of the cover 16 on the inside of the housing wall 14, i.e. in the interior of the housing 10 between the longitudinal ends 18 and 20 of the housing wall 14, the housing 10 can be described as a complex housing. Such a complex housing can be manufactured in one piece, i.e. monolithically, not as a formed part from a single blank.

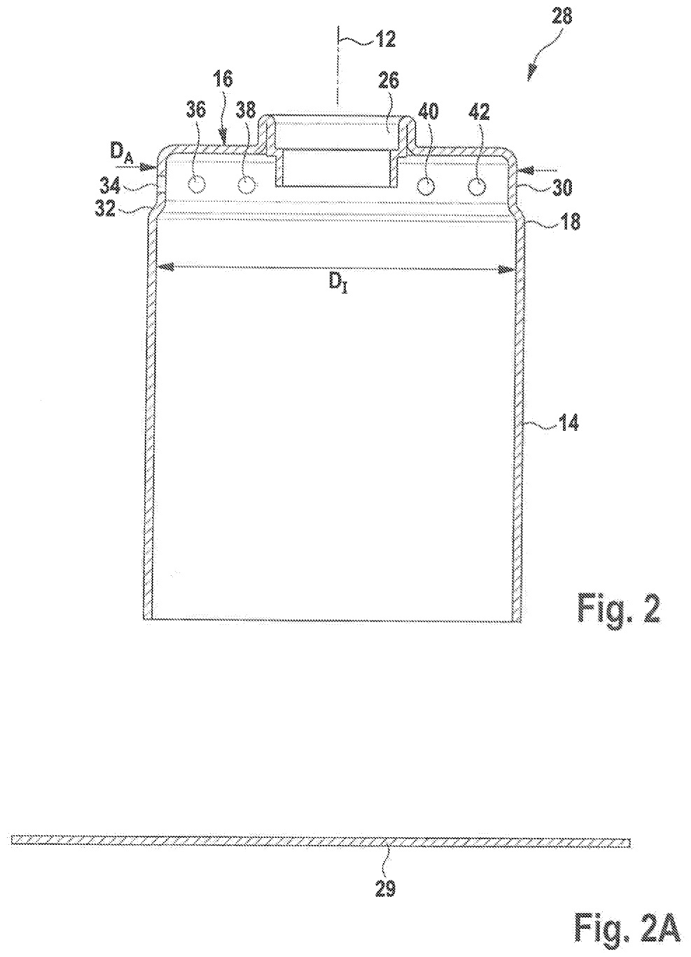

With reference to FIGS. 2 to 4, a method of manufacturing the housing 10 is described below.

Referring to FIG. 2, a precursor 28 of the housing 10 is provided. In the precursor 28 of the housing 10, the cover 16 is formed integrally with the housing wall 14 and is arranged at one of the longitudinal ends, in this case the longitudinal end 18, of the housing wall 14.

Since the cover 16 is arranged at one of the longitudinal ends of the housing wall 14 in the precursor 28, the precursor 28 can be manufactured in one piece, i.e., monolithically, in a conventional forming process by forming the housing wall 14 and the cover 16 together from a same blank. FIG. 2A shows (not to scale) a blank 29. The blank 29 may be monolithic, a tailored blank, or roll clad.

As part of the forming of the precursor 28 of the housing 10, the cover 16 is formed with a skirt 30 extending in the longitudinal direction of the housing wall 14 over a partial length of the housing wall 14 and in the circumferential direction about the longitudinal axis 12. The skirt 30 is integrally, i.e. monolithically, connected to the housing wall 14 by a shoulder 32 in the precursor 28. The skirt has an outer diameter D_{A} which corresponds to the inner diameter D_{I} of the housing wall 14. The outer diameter D_{A} of the skirt 30 is thus smaller than the outer diameter of the housing wall 14.

When forming the precursor 28 of the housing 10 from one and the same blank, the bearing flange 26 is also formed. In order to form the precursor 28 of the housing 10 from the blank 29, the forming operations deep-drawing, reverse drawing, reversing can be applied, as well as the machining operations perforating (for the through-opening of the bearing flange 26) as well as a lancing and a calibrating of the edge of the through-opening can be applied.

In addition, the skirt 30 may be perforated as part of the fabrication of the precursor 28 of the housing 10. Exemplary holes 34, 36, 38, 40, 42 are shown in FIG. 2. The holes 34-42 may be evenly spaced around the circumference of the skirt 30 about the longitudinal axis 12. The function of perforating the skirt 30 will be described later.

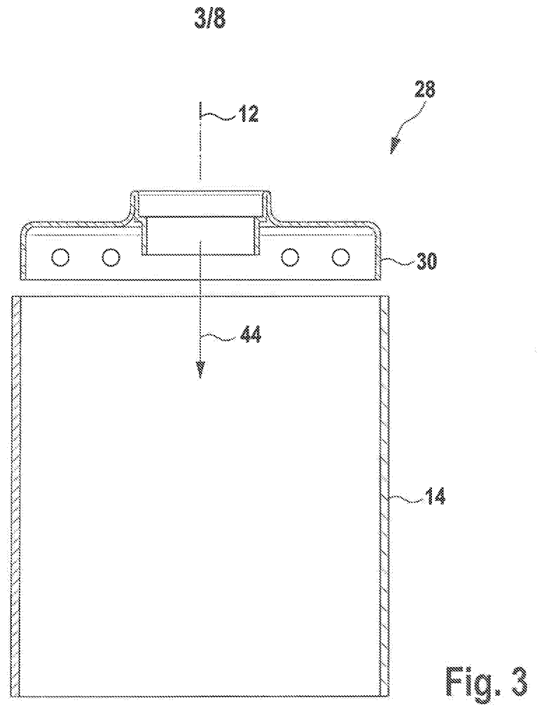

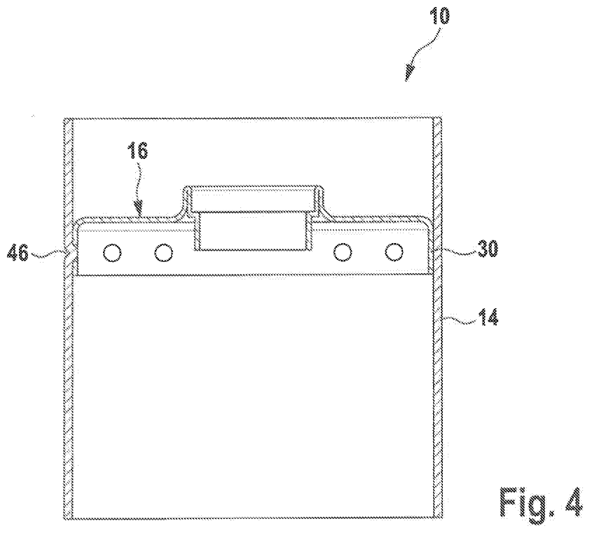

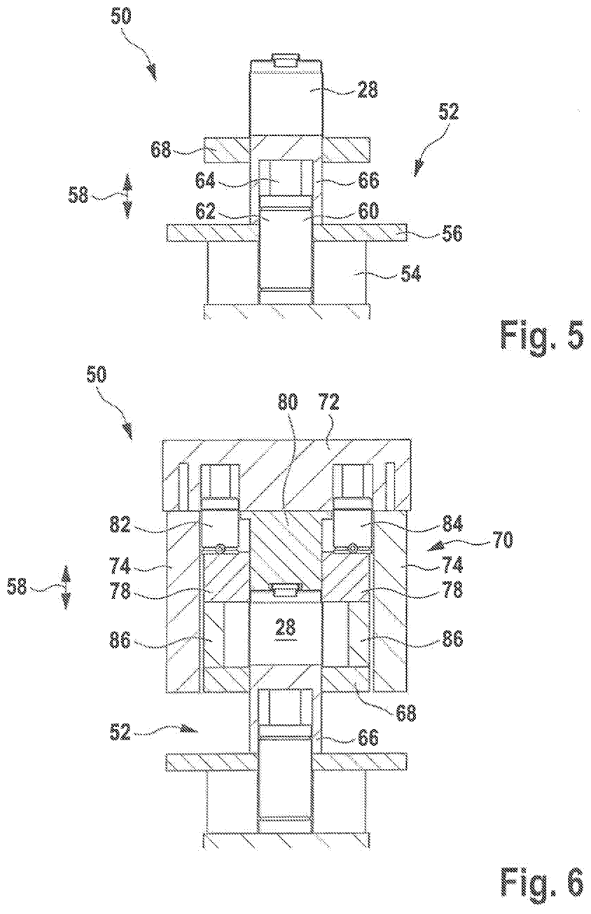

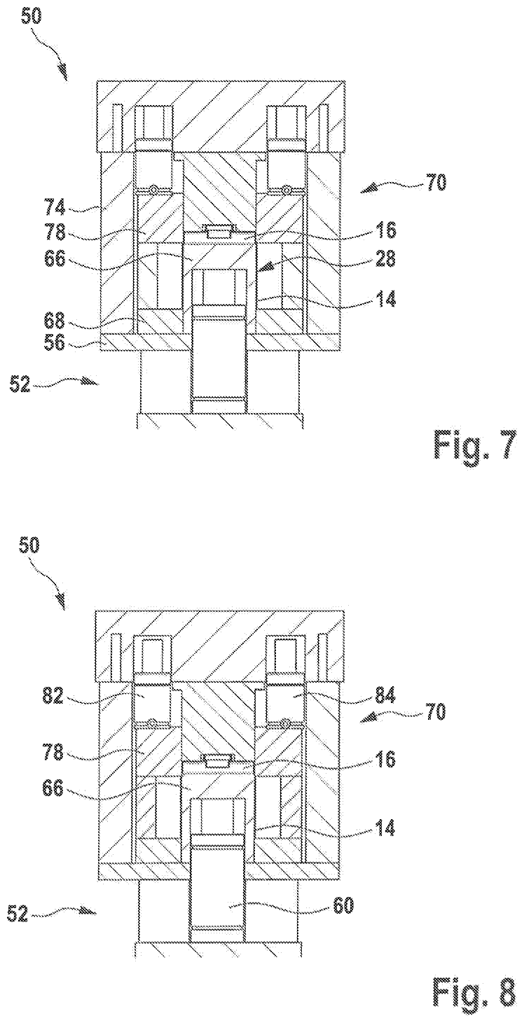

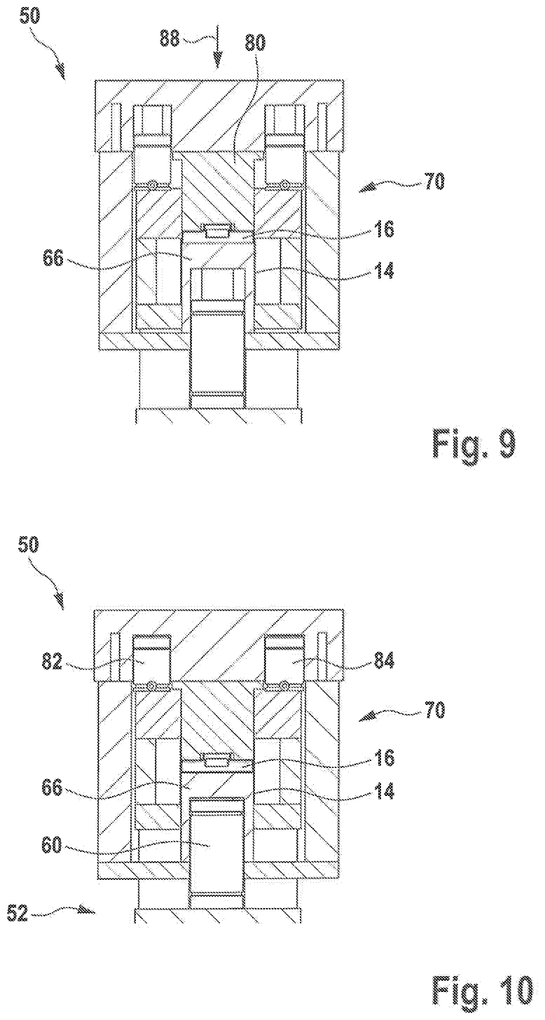

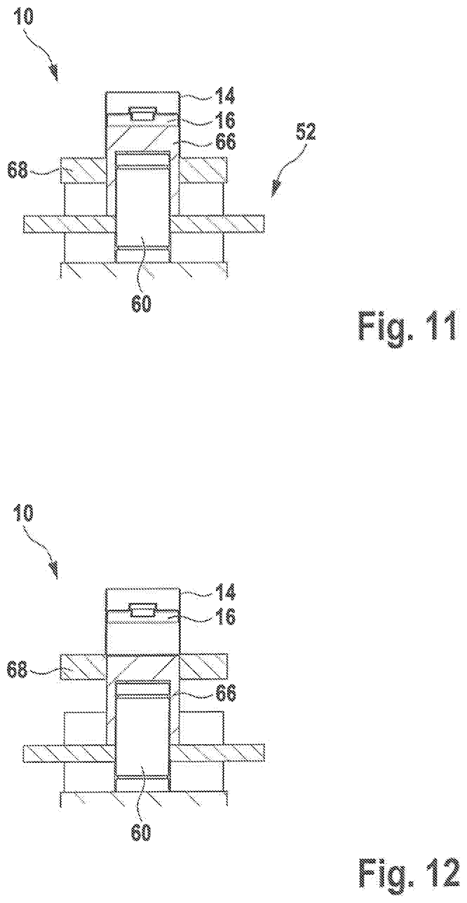

FIG. 3 shows a process stage of the method of manufacturing the housing 10, in which the cover 16 has been separated from the housing wall 14 at the precursor 28 of the housing 10 in FIG. 2. The separation takes place at the shoulder 32, i.e. the transition of the cover 16 to the housing wall 14. The separation process will be described in more detail later with reference to an embodiment of a corresponding device.

After separating the cover 16 from the housing wall 14, the cover 16 is displaced relative to the housing wall 14 along the longitudinal axis 12 in accordance with an arrow 44 into the predetermined position shown in FIGS. 1 and 4. Based on the above dimensioning of the outer diameter of the skirt 30 relative to the inner diameter of the housing wall 14, the outer surface of the skirt 30 fits snugly against the inner surface of the housing wall 14, as shown in FIG. 4. The dimensioning of the outer diameter of the skirt 30 relative to the inner diameter of the housing wall 14 may be such that the cover 16 is held in the predetermined position according to FIG. 4 by itself due to a corresponding frictional connection even without joining with the housing wall 14.

In a next process stage according to FIG. 4, the cover 16 is joined to the housing wall 14. Mechanical, thermomechanical or thermal joining processes can be used as joining process. For example, the skirt 30 can be welded to the housing wall 14. A circumferential weld can be used to join the skirt 30 to the housing wall 14 in a pressure-tight manner. A mechanical joining of the cover 16 to the housing wall 14 may comprise engaging the housing wall 14 with the perforation (holes 34-42 in FIG. 2), as illustrated at a location 46. This can be accomplished, for example, by pressing the housing wall 14 into the holes 34-42, which has the advantage that the housing 10 remains pressure-tight to the outside. If a pressure-tight design of the housing 10 is not required, the housing wall 14 can also be cut in the area of the perforation of the skirt 30 and material of the housing wall 14 can be bent over into the holes 34-42.

The engagement of the material of the housing wall 14 with the perforations of the skirt 30 prevents the cover 16 from rotating with respect to the housing wall 14.

Mechanical joining of the cover 16 to the housing wall 14 can also be done entirely without holes, for example by crimping joints such as toxing, clinching, etc.

Thermomechanical joining of the cover 16 to the housing wall 14 is also conceivable.

The above operations of forming the precursor 28 of the housing 10 from the blank 29, separating the cover 16 from the housing wall 14, displacing the cover 16 into the interior space of the housing wall 14, and joining the cover 16 to the housing wall 16 can be carried out altogether in the same apparatus having a corresponding plurality of working stations or stages. This is described in more detail below with reference to FIGS. 5 to 10.

FIGS. 5 and 6 show a working station 50 of an apparatus for manufacturing the housing 10 in FIG. 1. The apparatus is described below in terms of the operations of separating the cover 16 from the housing wall 14 and positioning the cover 16 relative to the housing wall 14.

The entire apparatus for manufacturing the housing 10 may further comprise a forming device for forming the cover 16 and the housing wall 14 in one piece from a same blank in one or more forming stages, as well as further working stations (e.g. perforating, calibrating, lancing) to manufacture the precursor 28 of the housing 10 according to FIG. 2. Since such forming devices with several forming stages and processing devices are familiar to the person skilled in the art, they are not shown in the drawing and are not described further here.

FIG. 5 shows a lower portion 52 of the working station 50. The lower portion 52 includes a fixed platform or base 54. The lower portion 52 further comprises a movable table 56 that is vertically movable according to a double arrow 58. The lower portion 52 further comprises a gas pressure or hydraulic spring 60 having a cylinder 62 and a piston 64. The piston 64 is also vertically movable according to the double arrow 58. Furthermore, the lower part 52 has a separating plunger 66, which can also be moved vertically according to the double arrow 58. The separating plunger 66 is part of a separating device for separating the cover 16 from the housing wall 14. The lower part 52 has an upward-mover 68 that can be moved vertically according to the double arrow 58.

The device 50 further comprises an upper part 70, which is shown in FIG. 6 together with the lower part 52. The upper part 70 comprises a frame or bridge 72, 74. The bridge 72, 74 is vertically movable (according to the double arrow 58). The upper part 70 further comprises a cutting die 78, which together with the separating plunger 66 forms the separating device for separating the cover 16 from the housing wall 14. The cutting die 74 is movable according to the double arrow 58.

The upper part 70 further comprises a pusher or slider 80 fixed to the bridge for displacing the cover 16 relative to the housing wall 14 after the cover 16 has been separated from the housing wall 14. The upper portion 70 further includes gas pressure or hydraulic springs 82, 84 and a spacer 86.

According to FIG. 5, the precursor 28 of the housing 10 is placed on the separating plunger 66 after it has been manufactured in the forming device of the apparatus. In this case, the separating plunger 66 is seated on the piston 64 of the gas pressure or hydraulic spring 60, with the piston 64 in its extended position. The upward-mover 68 is in its raised position.

According to FIG. 6, the upper part 70 of the device 50 is now moved towards the lower part 52. By moving the upper part 70 down further, the pusher 80 pushes or presses the precursor 28 of the housing as a whole over the separating plunger 66 into the position shown in FIG. 7. The upward-mover 68 is likewise pressed down in the process via the spacer 86. The cutting die 78 is also moved downward.

In FIG. 7, the precursor 28 is now fully seated on the separating plunger 66, with the inside of the cover 16 resting on the top of the separating plunger 66. The upward-mover 68 and the frame 74 rest on the table 56.

FIG. 7 shows the moment immediately before the cover 16 is separated from the housing wall 14 of the precursor 28 of the housing 10.

FIG. 8 shows the separation process for separating the cover 16 from the housing wall 14 of the precursor 28 of the housing 10. The separation of the cover 16 from the housing wall 14 takes place at the shoulder 32 between the skirt 30 of the cover 10 and the longitudinal end 18 of the housing wall 14 by a relative movement between the cutting die 78 and the separating plunger 66.

The cutting die 78 is held in position and the upper gas pressure or hydraulic springs 82, 84 retract.

According to FIG. 9, the cover 16 is pressed down together with the separating plunger 66 by further moving the upper part 70 downward via the pusher 80 according to an arrow 88. The housing wall 14 is held stationary in the process. Thus, by moving the upper part 70 downward in accordance with the arrow 88, the cover 16 is displaced into the interior space defined by the housing wall 14 until the cover 16 has reached the axial predetermined position relative to the housing wall 14, as shown in FIG. 10. The gas pressure or hydraulic spring 60 retracts during the displacement of the cover 16 relative to the housing wall 14, as do the gas pressure or hydraulic springs 82 and 84.

The separating plunger 66 is now in the bottom dead center position, as is the upper part 70 of the device 50. The gas pressure or hydraulic spring 60 is locked in position. The upper part 70 is then moved away from the lower part 52, as shown in FIG. 11.

The upward-mover 68 is then moved upward to remove the housing 10 from the separating plunger 66, as shown in FIG. 12. The housing 10 can now, in a further cycle of the apparatus, be transferred to a joining device of the apparatus (not shown) in which the cover 16 is joined to the housing wall 14, as described above with reference to FIG. 4.

However, the joining of the cover 16 to the housing wall 14 can also be performed at the process stage shown in FIG. 11, i.e., before the housing 10 is removed from the separating plunger 66.

The above-described separation of the cover 16 from the housing wall 14 and the displacement of the cover 16 relative to the housing wall 14 into the interior of the housing wall 14 can take place in the press cycle of the device. The separating and positioning process is preceded by the forming operations, also in the press cycle. The separating and positioning operation may be followed, in the same apparatus, by the joining of the cover 16 to the housing wall. In this way, the housing 10 can be produced in the press cycle in a simple manner and with little tooling.

What is claimed is:

1. A method of manufacturing a housing, the housing to be manufactured having a sleeve-shaped housing wall extending about a longitudinal axis of the housing and a cover disposed inside the housing wall transverse to the longitudinal axis at a predetermined position between longitudinal ends of the housing wall, the method comprising:
providing a precursor of the housing in which the cover is integrally formed with the housing wall and is arranged at one of the longitudinal ends of the housing wall,
separating the cover from the housing wall, and
displacing the cover relative to the housing wall in the direction of the longitudinal axis from the one longitudinal end into the predetermined position.

2. The method of claim 1, wherein providing the precursor of the housing comprises jointly integrally forming the housing wall and the cover from a same blank.

3. The method of claim 2, wherein forming of the housing wall and the cover is performed in a same apparatus as the separation and displacement of the cover.

4. The method of claim 1, wherein providing the precursor of the housing comprises forming the cover with a skirt extending in longitudinal direction of the housing wall along a partial length of the housing wall and circumferentially about the longitudinal axis.

5. The method of claim 4, wherein an outer diameter of the skirt corresponds to the inner diameter of the housing wall.

6. The method of claim 4, wherein providing the precursor of the housing comprises perforating the skirt such that the skirt is provided with one or more holes therein.

7. The method of claim 1, further comprising joining the cover to the housing wall in the predetermined position.

8. The method of claim 7, wherein joining the cover to the housing wall comprises at least one of mechanical, thermal, or thermomechanical joining.

9. The method of claim 4, wherein providing the precursor of the housing comprises perforating the skirt, the method further comprising joining the cover to the housing wall, wherein joining the cover to the housing comprises engaging the housing wall with the one or more holes of the skirt of the cover.

10. The method of claim 1, wherein joining the cover to the housing wall is performed in a same apparatus as the separation and displacement of the cover.

11. The method of claim 1, wherein providing the precursor of the housing comprises forming the cover as a bearing flange.

12. An apparatus for performing a method according to claim 1, the apparatus comprising:
a separating device for separating the cover from the housing wall, and
a positioning device for displacing the cover relative to the housing wall in the direction of the longitudinal axis into the predetermined position.

13. The apparatus of claim 12, further comprising a manufacturing device for manufacturing the precursor of the housing.

14. The apparatus of claim 13, wherein the manufacturing device comprises a forming device for jointly forming the cover and the housing wall in one piece from a same blank in one or more forming stages.

15. The apparatus of claim 12, further comprising a joining device for joining the cover to the housing wall in the predetermined position.

16. The apparatus of claim 12, wherein the separating device comprises a separating plunger onto which the precursor of the housing can be placed, and a separating die.

17. The apparatus of claim 12, wherein the positioning device comprises a pusher designed to displace the cover relative to the housing wall.

18. The apparatus of claim 13, wherein the manufacturing device comprises a perforating device for perforating a skirt of the cover to provide the skirt with one or more holes.

19. The apparatus of claim 18, further comprising a joining device for joining the cover to the housing wall in the predetermined position, wherein the joining device is adapted to engage the housing wall with the holes of the skirt.
